(19) United States
(12) Patent Application Publication
(10) Pub. No.: US 2025/0157022 A1
(43) Pub. Date: May 15, 2025

(54) UNSUPERVISED 3D MODELING AND GEOMETRIC MEASUREMENT OF PARTS BUILT WITH POWDER BED FUSION-BASED ADDITIVE MANUFACTURING

(71) Applicant: BWXT Advanced Technologies LLC, Lynchburg, VA (US)

(72) Inventor: Ryan Scott KITCHEN, Knoxville, TN (US)

(73) Assignee: BWXT Advanced Technologies LLC, Lynchburg, VA (US)

(21) Appl. No.: 18/944,030

(22) Filed: Nov. 12, 2024

Related U.S. Application Data
(60) Provisional application No. 63/598,971, filed on Nov. 15, 2023.

(51) Int. Cl. G06T 7/00; B33Y 50/00; G05B 19/4099; G06T 5/30; G06T 5/70; G06T 7/13; G06T 7/155; G06T 7/50; G06T 7/60; G06T 17/00

(52) U.S. Cl. CPC G06T 7/0004; B33Y 50/00; G05B 19/4099; G06T 5/30; G06T 5/70; G06T 7/13; G06T 7/155; G06T 7/50; G06T 7/60; G06T 17/00; G05B 2219/49023; G06T 2207/10048; G06T 2207/20036; G06T 2207/20132; G06T 2207/20152; G06T 2207/20156; G06T 2207/30136; G06T 2207/30164

(57) ABSTRACT

A method is provided for unsupervised 3D modeling and geometric measurement of additively manufactured parts. The method includes obtaining near-infrared (NIR) images for a welding process for a welded part. The welded part includes welded metal and agglomerated powder particles. The method also includes generating a multi-dimensional dataset based on the NIR images, including cropping the multi-dimensional dataset to a region of interest. The method also includes detecting melted regions in image layers of the multi-dimensional dataset to obtain an output volume. The method also includes detecting agglomerated powder in the output volume to obtain melt masks. Each melt mask indicates weld pixels for a respective image layer. The method also includes applying a multi-layer predictive model to account for multi-layer weld penetration, based on the melt masks, to obtain an output data mask that represents a 3D model and geometric measurements for the welded part.

### CROSS-REFERENCE TO RELATED APPLICATIONS

This application is based on and claims priority under 35 U.S.C. § 119 to U.S. Provisional Application No. 63/598,971, filed Nov. 15, 2023, the entire contents of which are incorporated herein by reference.

### STATEMENT REGARDING FEDERALLY SPONSORED RESEARCH OR DEVELOPMENT

The invention described herein was made in the performance of work under DOE Cooperative Agreement No. DE-NE0008744. The Government has certain rights in this invention.

### TECHNICAL FIELD

Disclosed implementations relate generally to additive manufacturing and more specifically to systems and methods for unsupervised 3D modeling and geometric measurement of parts for additive manufacturing.

### BACKGROUND

Additive processes can be monitored by modeling of 3D printed metal parts using a camera. Existing methods use the fact that hot melted (solid) metal has a substantially lower emissivity in the near-infrared (NIR) and infrared (IR) spectrum than the heated powder at a similar temperature. An NIR or IR camera is used to capture an image of each layer. A simple threshold on the light-corrected image is used to differentiate melted regions from un-melted powder. Due to variations in surface temperature across the build area (which introduces noise and error), the input model is used to mask out expected print regions.

However, these methods have limited accuracy and may fail to detect variations in weld pool width when it exceeds the commanded size (due to the masking of expected print area). Additionally, the final finished part consists of both welded metal and agglomerated powder particles, which are sintered/bonded to the edges of melt areas. These agglomerated powder particles cannot be differentiated from un-melted powder by using thresholds or other basic image processing methods and are generally ignored by all existing optical geometric measurement methods or known prior art. This problem adds a significant amount of error when the printed part consists of thin walls, when the powder size is closer to the size of the weld pool, or when the additive process utilizes sintering to stabilize the powder bed (as is the case with any electron beam welding method). In some cases of extremely thin walls, powder agglomeration can account for more than 80% of the total wall thickness, which means a weld-only measurement would give an error rate of over 400%. Additionally, the edges of the weld pool may extend underneath un-melted powder, which prevents existing detection systems from visually identifying it.

Computed tomography (CT) scanning is an alternative to 3D modeling. However, this alternative has major limitations when used on materials with high density, or on large components with complex internal geometries. CT scans suffer from visual artifacts on these kinds of components, due to shadows created by beam hardening effects, attenuation due to material density, and limitations in the reconstruction of data.

### SUMMARY

Accordingly, there is a need for solutions for monitoring additive processes that address at least some of the problems described above. Techniques described herein have the advantage that they can be used to produce a non-destructive testing (NDT) data set, which is approximately equivalent to a CT scan of the same resolution, without any additional cost or time delay. Unlike CT scanning, these techniques help maintain a uniform level of accuracy across the entire component regardless of component size, complexity, and material density. This is a major advantage when working with highly dense materials, such as those found in nuclear core components. The techniques described herein can be used to reconstruct a 3D model of printed parts from NIR/IR images with a high degree of geometric accuracy, without using an input computer-aided design (CAD) model as a reference. Some implementations also incorporate highly accurate porosity defect detection into the 3D model. By incorporating a predictive model based on experimentally gathered data, it is possible to account for inter-layer melt effects, agglomerated powder, and porosity defect healing across multiple layers.

Moreover, unlike conventional methods, the techniques described herein are accurate on thin-walled structures and components with fine details. Thin walls or fine details include geometric features with sizes approaching the minimum viable feature size of the underlying technology. On a laser or electron beam powder bed fusion additive manufacturing system, the minimum viable feature size is the minimum weld pool size for a single weld. The upper bound for the geometric features include the minimum detectable feature size of conventional geometry detection technologies available for a particular additive machine. Accuracy at minimum feature size assumes the layer camera has a resolution with pixel sizes smaller than ½ of the minimum feature size.

In accordance with some implementations, a method executes at a computing system. Typically, the computing system includes a single computer or workstation, or a plurality of computers, each having one or more CPU and/or GPU processors and memory. The method does not generally require a computing cluster or supercomputer.

The method includes obtaining a plurality of near-infrared (NIR) images for a welding process. Each NIR image corresponds to a respective layer after melting of the respective layer during the welding process for a welded part. The welded part includes welded metal and agglomerated powder particles, which are sintered or bonded to edges of melt areas. The method also includes generating a multi-dimensional dataset based on the plurality of NIR images, including cropping the multi-dimensional dataset to a region of interest. The multi-dimensional dataset includes as many image layers as a number of images in the plurality of NIR images. The method also includes detecting melted regions in each image layer of the multi-dimensional dataset to obtain an output volume. The method also includes detecting agglomerated powder in the output volume to obtain melt masks. Each melt mask indicates weld pixels for a respective image layer. The method also includes applying a multi-layer predictive model to account for multi-layer weld penetration, based on the melt masks, to obtain an output data mask that represents a 3D model and geometric measurements for the welded part.

In some implementations, generating the multi-dimensional dataset includes organizing the plurality of NIR images into a 3D volumetric dataset including creating a 3D array and loading of the plurality of the NIR images into the 3D array.

In some implementations, the welding process is based on an electron beam system; in other embodiments, the welding process is based on a laser system.

In some implementations, the welding process is based on an electron beam system, and cropping the multi-dimensional dataset includes: condensing the multi-dimensional dataset to a single image by computing a mean value of each pixel across an axis representing layers, including thresholding the mean value based on a predefined boundary to create a mask of a known preheated powder; cropping the single image to an outside boundary of the region of interest to obtain a cropped image; and applying the mask of the known preheated powder to mask any value outside the cropped image.

In some implementations, cropping the multi-dimensional dataset includes: condensing the multi-dimensional dataset to a single image by computing a minimum value for each pixel across an axis representing the layers, including thresholding each minimum value, to create a mask of locations with a melted metal; denoising the mask of locations to remove any anomalous isolated low values; and cropping the single image to an area around the outside of the mask, adding a buffer or margin around the region of interest.

In some implementations, detecting the melted regions includes applying a fizzle algorithm to each image layer to simultaneously intensity-normalize and amplify features or local gradients, to obtain a respective fizzled image. The fizzle algorithm is a local feature detection algorithm that measures relative intensity change of a pixel compared to a local region; generating a respective labeled mask for each fizzled image by (i) annotating high-confidence known weld pixels with a first value, where the pixels are identified using a low-pass threshold, (ii) identifying and masking high-confidence known powder areas with a second value using a high-pass threshold, (iii) filling remaining unlabeled values with a third value, and (iv) denoising to remove isolated labels. The method further includes segmenting each image layer using the respective labeled mask as a seed and using a seeded segmentation algorithm to obtain a respective segmented output; and labelling each image layer to indicate material or weld present for each first value in the respective segmented output, to obtain the output volume.

In some implementations, denoising to remove isolated labels includes removing isolated points from the fizzled image that are not part of a connected chain.

In some implementations, the seeded segmentation algorithm is a watershed algorithm for identifying boundaries between materials with different coloration, ignoring gradual changes in coloration, lighting, or other characteristics.

In some implementations, detecting the agglomerated powder includes: obtaining a respective input melt mask indicating weld pixels for each image layer; applying a contextual fizzle algorithm to each image layer using a negative of the respective input melt mask in order to identify local thermal gradients in powder, to obtain a respective fizzled image. The contextual fizzle algorithm is a local feature detection algorithm that measures relative intensity change of a pixel compared to a local region, alters a local mean to only consider pixels that belong to a contiguous region that has similar intensity; applying a high-pass threshold to each fizzled image to identify superheated powder in each input melt mask; applying a morphological dilate filter to each input melt mask, with a kernel size sufficient to capture agglomerated powder to obtain a respective dilated melt mask; generating a respective output melt mask for each input melt mask based on marking a first value for any pixel for which both the high-pass threshold and the first value on the dilated melt mask are present; and applying a morphological close filter to each output melt mask to fill in gaps between the identified superheated powder in each input melt mask.

In some implementations, a multi-layer predictive model is used to account for the weld pool depth being more than one layer thickness deep”

In some implementations, applying the multi-layer predictive model includes accounting for weld pool depth being more than one layer thickness deep.

In some implementations, the predictive model utilizes physical measurements with test samples, and microscopy on an etched vertical cross section of a test sample is used to determine machine-specific weld pool penetration depth on a material in question.

In some implementations, applying the multi-layer predictive model includes: generating the output data mask that includes a respective output mask for each image layer where the melt mask has a first value, including: obtaining a maximum depth in number of layers, a maximum half-width, and a half-width of a weld pool for each image layer in a depth range; for each penetration layer in the depth range except a top layer, applying a morphological erosion kernel to its respective melt mask to create a layer-specific melt mask, where the kernel size is determined by

$$ksize = 2 * floor ( \frac{( maximum halfwidth ) - ( current halfwidth )}{pixel width} ) + 1 ;$$

and marking locations, in the respective output mask, where the layer-specific melt mask has the first value, which indicates that the locations correspond to welded metal.

In some implementations, the method further includes annotating the output volume with porosity defects.

In some implementations, annotating the output volume with porosity defects includes: for each layer in the output volume, using a contour detection method on the labeled output for the layer to identify interior (negative) and exterior (positive) contours around material regions; filtering the contours based on criteria including (i) interior pores only, (ii) low-pass threshold on total contour area, and (iii) geometric characteristics; and mapping the filtered contours onto the output volume with a label to indicate a presence of defect.

In some implementations, annotating the output volume with porosity defects includes: for each layer in the output volume: using a masked contextual fizzle local anomaly detection algorithm on the layer images, using material regions from the output volume as a mask, to obtain a fizzled image; applying a high-pass threshold to the fizzled image using a predetermined value based on a sample image, to identify any hotspots in a melt region that exceed the threshold, to obtain a threshold mask; using a contour detection algorithm on the threshold mask to identify contours of individual pores; filtering the contours based on total area, to indicate whether the contours contain internal solid regions, circularity, or convexity; and mapping the filtered contours onto the output volume with a label to indicate a presence of defect.

In some implementations, the method further includes writing the output data mask for downstream volumetric data analysis, to a standard Hierarchical Data Format version 5 (HDF5) data storage format.

In some implementations, the method further includes writing the output data mask for downstream volumetric data analysis, to a visualization toolkit (VTK) format.

In some implementations, the method further includes writing the output data mask for usage in modeling and simulation.

In some implementations, a computing system includes one or more computers. Each of the computers includes one or more processors and memory. The memory stores one or more programs that are configured for execution by the one or more processors. The one or more programs include instructions for performing any of the methods described herein.

In some implementations, a non-transitory computer readable storage medium stores one or more programs configured for execution by a computing system having one or more computers, each computer having one or more processors and memory. The one or more programs include instructions for performing any of the methods described herein.

Thus, methods and systems are disclosed that efficiently obtain 3D models and geometric measurements of additively manufacture parts.

### BRIEF DESCRIPTION OF THE DRAWINGS

For a better understanding of the disclosed systems and methods, as well as additional systems and methods, reference should be made to the Description of Implementations below, in conjunction with the following drawings in which like reference numerals refer to corresponding parts throughout the figures.

FIG. 1A shows an example near-infrared (NIR) layer image, according to some implementations.

FIG. 1B shows an example process for cropping and masking datasets to a region of interest, according to some implementations.

FIG. 1C shows an example view of a weld, according to some implementations.

FIG. 2 shows an example cross section of a welding part, according to some implementations.

FIG. 3A shows an example of a basic fizzle, according to some implementations.

FIG. 3B shows an example of mask generation, according to some implementations.

FIG. 3C shows an example result of mask generation, according to some implementations.

FIG. 3D shows an example of an output (for masked area) from the basic fizzle, according to some implementations.

FIG. 3E shows an example of an output from the masked (contextual) fizzle, according to some implementations.

FIG. 4 is a block diagram illustrating a computing device in accordance with some implementations.

FIG. 5 shows a flowchart of an example method for unsupervised 3D modeling and geometric measurement of additively manufactured parts, according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

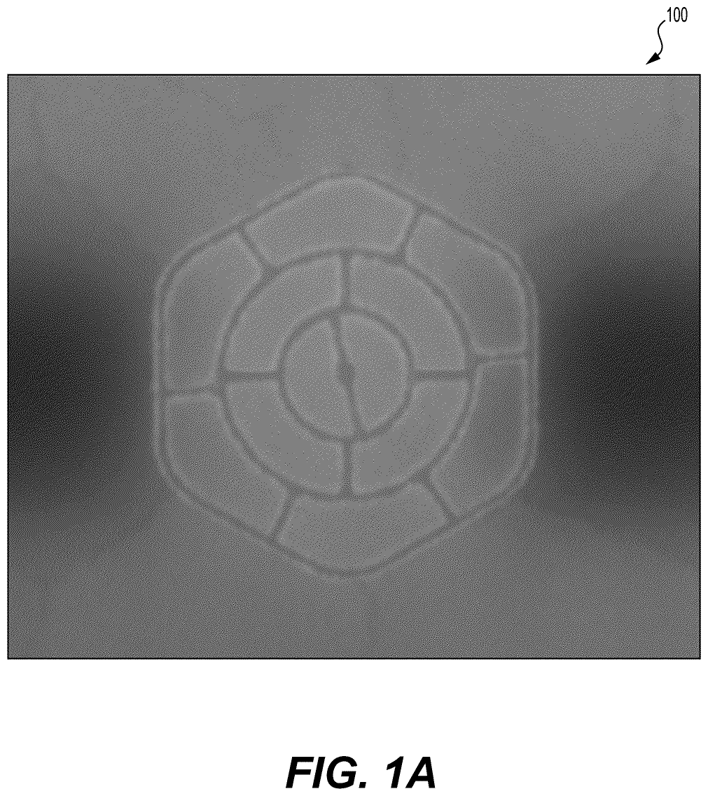

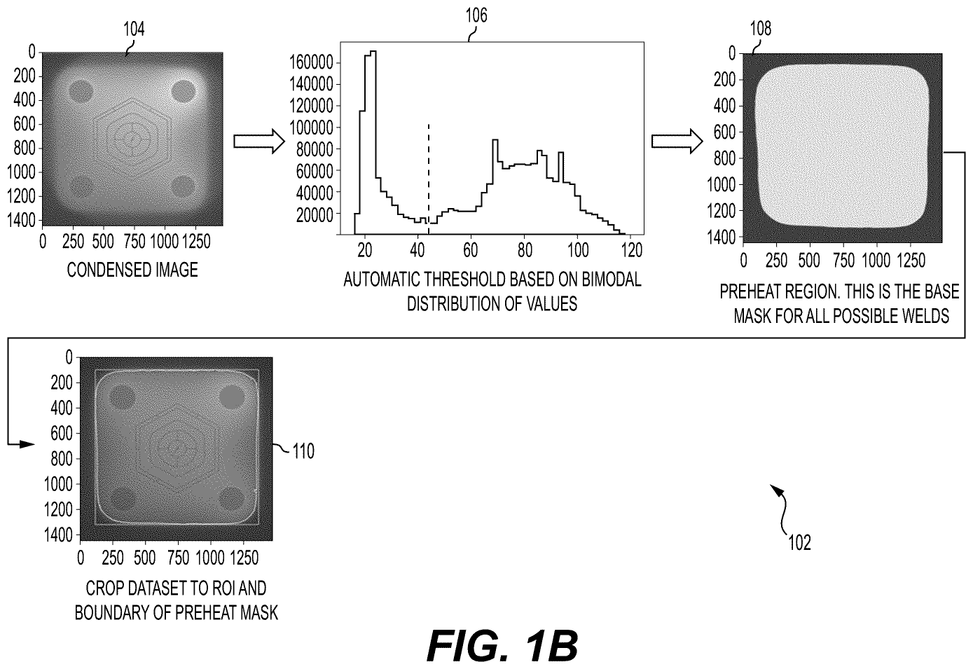

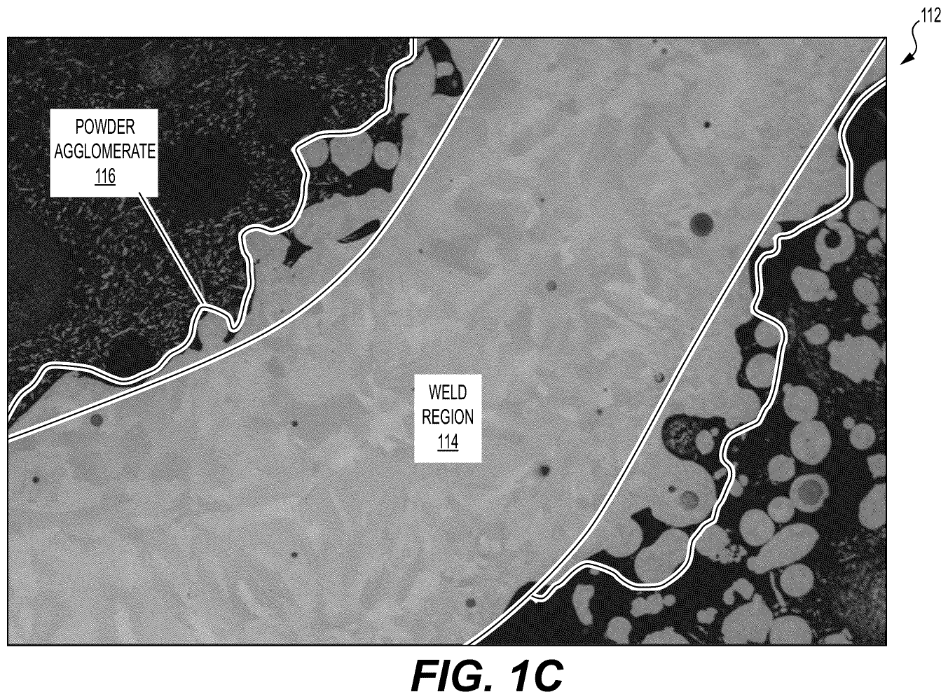

The techniques described herein may be implemented using an electron beam metal additive printer (e.g., Arcam Spectra H) using metal powders (e.g., Hastelloy X powder). Some additive printers use a monochrome camera (e.g., Allied Vision Prosilica GT6600 28MP), which is equipped with a long-pass NIR filter that can be configured to automatically image the build plate after each print layer. This camera/lens combination has a pixel size that equates to approximately 85 microns of build plate. Some implementations use an improved lens to decrease the pixel size to approximately 60 microns. For input data, some implementations use a collection of near-infrared (NIR) images captured shortly after the melting of each layer is completed. FIG. 1A shows an example NIR layer image 100, according to some implementations.

Some implementations gather post-weld layer images into a 3D volumetric dataset. In some implementations, this step includes creation of a 3D array in computer memory, and the loading of an image file into this array.

### Cropping Dataset to a Region of Interest (ROI)

Some implementations crop the 3D volumetric data to a region of interest (ROI) as follows. For an electron beam, the ROI is the region of the build area that is preheated. Some implementations perform one or more of the following steps for electron beam systems: (i) condense the 3D volumetric dataset to a single image by taking the mean value of each pixel across the z-axis that corresponds to the layers; (i) threshold the mean value based on a predefined lower boundary (calibrated based on material emissivity and camera settings), which creates a mask of known preheated powder; (iii) crop the dataset/images to the outside boundary of the preheat ROI; and (iv) mask out any values outside the cropped ROI. This last step is necessary as low intensity values of non-preheated powder may be considered false positives by the following melt detection algorithm described below. This operation is safe since the preheated area will extend beyond any printed material.

For laser systems, the ROI is the area that contains melted metal. Some implementations perform one or more of the following steps for laser systems: (i) condense the dataset to the minimum value for each pixel across the z-axis, potentially ignoring the first few layers as the build plate is visible; (ii) threshold this minimum value to mask all locations with melted metal; (ii) denoise or erode the image to remove any anomalous isolated low values; and (iv) crop the image to the area around the outside of the mask, adding a buffer/margin around the ROI to ensure full capture of details. FIG. 1B shows an example process 102 for cropping and masking datasets to a region of interest, according to some implementations. A threshold based on bimodal distribution of values 106 is applied to a condensed image 104 to obtain a preheat region 108, which is used as a base mask for all possible welds. The preheat region 108 or dataset is cropped 110 to a region of interest and the boundary of the preheated mask. The dataset is reduced in size (cropped) and masked (areas outside the mask are ignored).

### Detecting Melted Regions in Layers, Creating a New Labeled Volumetric Dataset

Some implementations detect melted regions in each layer and create an output volume (sometimes referred to as a new labeled volumetric dataset or a new labeled multi-dimensional dataset). This step may include creating a mask labeling each pixel in the layer image to identify known melt, known powder and unknown. This step may also include applying a fizzle algorithm to the image to simultaneously intensity-normalize and amplify features/local gradients. Details and examples of the fizzle algorithm are described below. This step may also include creating a mask annotating high-confidence known weld pixels (e.g., annotating with a value of 1). These pixels are identified using a low-pass threshold on the fizzled image. The value for this threshold may need to be calibrated on a per-material basis. Some implementations utilize a threshold of 90% of the local mean (a 0.9 fizzle value) as the upper bounds, across multiple materials. This step may also include identifying and masking high-confidence known powder areas with a value of 2 using a high-pass threshold on the fizzled image. Some implementations use 110% of the local mean (a 1.1 fizzle value) as the lower bounds. This step may also include filling in the remaining, unlabeled values (e.g., filling in with a value of 0). This step may also include denoising the mask to remove isolated labels (an example denoising algorithm is described below). This step may also include using the labeled mask as a seed, and the original image or a lighting corrected version as the input, segmenting the image using a seeded segmentation algorithm, such as a watershed algorithm, an example of which is described below, according to some implementations. This step may also include labelling the corresponding layer in the initial output volume or array for material or weld present (e.g., label using the value of 1) for each value set (e.g., a value of 1) in the segmented output. The output volume is a volumetric data set. Each operation involving the output volume is performed as a modification to this dataset in-place rather than by copying or duplicating the output volume, unless specified otherwise.

Annotation of Volume with Porosity Defects

Some implementations annotate the volume with porosity defects as follows. Depending on the emissivity of pores relative to preheated or un-melted powder in the particular system and material used for welding, these defects may be identified using different methods. One such method is a void-based method that includes the following steps. A first step uses a contour detection method on the labeled output for each layer in the output volume. Some implementations use the Suzuki and Be contour detection algorithm included in the OpenCV library, configured to output interior (negative) and exterior (positive) contours around the material regions. A second step filters the contours based on criteria, such as the following: (i) interior pores only, which means only voids inside of known material regions (e.g., areas classified as weld present or having a value of 1) are considered as candidates, (ii) low-pass threshold on total contour area (this is the maximum void size that will be considered a pore and anything larger than this is simply output as component geometry, so the value should be set to below the minimum designed internal void cross-sectional area), and (iii) geometric characteristics, such as circularity. In some implementations, part (i) is always used as a criteria but part (ii) may be optional. As a third step, the void-based method includes drawing the filtered contours onto the output volume with a distinct label (e.g., a label with a value of 2) to indicate defect presence.

Another method for annotating the volume with porosity defects is a context-sensitive defect detection method. This method is used when the increased emissivity of pores is insufficiently bright to be classified by the melt detector as a non-melt region. This can also be used in combination with the void-based method (described above) to identify smaller pores, which may not be picked up by that method. For each layer in the output volume, the method includes (i) using a masked contextual fizzle local anomaly detection algorithm (an example of which is described below) on the layer images, using known material regions (e.g., a value of 1 in the output dataset) from the output volume as the mask (for the layer images, the original image is used as the input, with the output weld region (output volume equal to 1) used as the contextual mask), (ii) applying a high-pass threshold to the fizzled image using an experimentally determined value based on a sample image (which will identify any hotspots in the melt region that exceed the threshold), (iii) using a contour detection algorithm on the threshold mask to identify individual pores, (iv) filtering the contours based on total area, whether they contain internal solid regions, and circularity/convexity (this can help filter out other types of defects picked up by the anomaly detector, such as cracking, swelling, and non-pore thermal hotspots), and (v) drawing the filtered contours onto the output volume with a distinct label (e.g., a label with a value of 2).

### Accounting for Powder Agglomeration

Some implementations account for powder agglomeration. Depending on the quality and size of the powder used, machine process parameters, and the material in question, un-melted powder may sinter or agglomerate to the sides of the metal. This is more common in alloyed materials than in pure elemental metals. Agglomerated powder can be detected in NIR imagery because the powder is partially fused with the component, leading to heat conduction into the powder from the nearby weld regions. This results in measurably higher NIR emissions as compared to both other powder and to the base metal.

Some implementations detect agglomerated powder by performing the following steps: (i) apply the contextual fizzle algorithm to the layer images using the negative/inverse of the melt mask in order to identify local thermal gradients in the powder; (ii) apply a conservative high-pass threshold to the fizzled image to identify superheated powder; (iii) apply a standard morphological dilate filter to the melt mask, with the kernel size sufficient to capture agglomerated powder (this may be determined empirically by sampling measurements from microscopy imagery, or can be set to a default value of 2 times the powder diameter if the empirical data is unavailable); (iv) mark any pixel for which both the high-pass threshold and a value of 1 on the dilated melt mask are present, as 1 in the output melt mask (optionally, this is another value to indicate the presence of powder agglomeration, if desired as an output); and (v) apply a morphological close filter to the output melt mask to fill in the gaps between the identified superheated powder and the component geometry. The kernel size is the same as the dilate range.

### Multi-Layer Predictive Model to Account for Multi-Layer Weld Penetration

Some implementations use a model that accounts for weld pool depth that is more than one layer thickness in depth. This weld pool depth is useful for powder bed fusion (PBF) based additive manufacturing in order to fully adhere each layer to the previous layer. In some processes, the powder diameter is often close to the weld pool size (within an order of magnitude in electron beam melting (EBM)). So there is a high degree of randomness in the weld width and shape based on the random positioning of powder particles, especially on the edges of the component. FIG. 1C shows an example view 112 of a weld, according to some implementations. The example shows a weld region 114 and a powder agglomerate 116. As shown, the width of the weld region 114 varies, and may depend on the position of the powder agglomerate 116. As a result of this randomness, the final geometry of a layer is a combination of its own shape as measured in the NIR, and the penetrated weld from layers above it. This can also have the effect of eliminating lack of fusion porosity by re-melting the region and adding additional material, causing pores to heal. According to some implementations, the predictive model utilizes physical measurements from test samples. Microscopy on an etched vertical cross section test sample is used to determine the machine-specific weld pool penetration depth on the material in question. Due to overlapping welds, the average maximum weld depth is used to predict penetration for all pixels internal to the component, with a taper around the edges based on the weld shape.

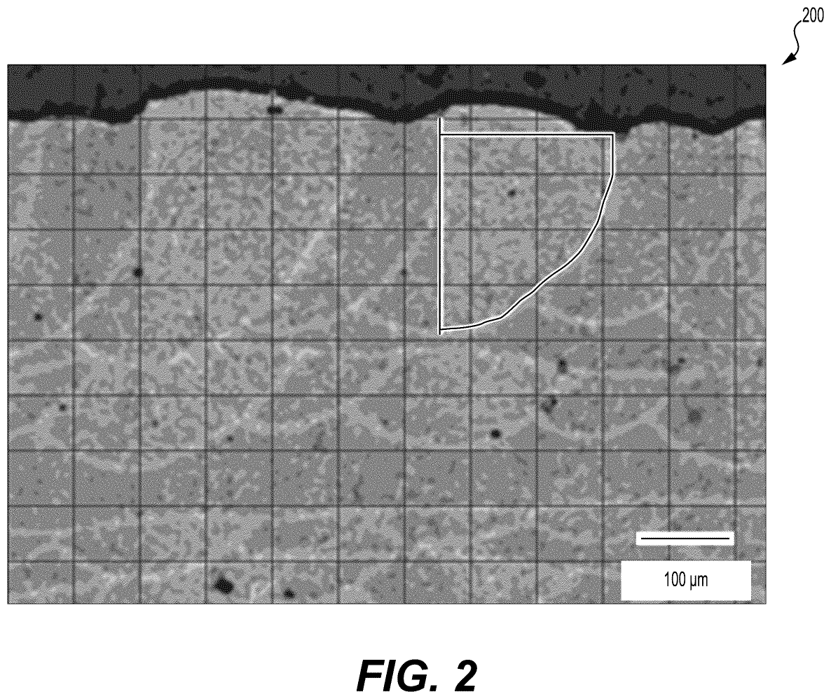

FIG. 2 shows an example etched micrograph 200 of a vertically sliced weld showing the weld pool penetration, according to some implementations. This micrograph is used to define the parameters of the predictive model described herein. The example shows segmentation in 50 micrometer (um) layer height increments and 60 um pixel size. Note that the estimated maximum penetration depth is approximately 200 um (4 layers) while the outside edge is approximately 150 um (3 layers). These values are used to contextually propagate detected melts downwards in the volumetric dataset. For example, pixels with a 1 value are propagated downwards by 3 layers for internal pixels and 2 layers for edge pixels. To propagate this data through multiple layers while accounting for the contour of the weld pool, some implementations use the following program:

For each print layer, starting with the first:
a. A melt mask is created for the current layer where the output melt mask is 1;
b. Input parameters are the maximum depth in number of layers, maximum half-width, and half-width of the weld pool at each layer in the depth range;
c. For each of the penetration layers except the top (current) layer, a standard morphological erosion kernel is applied to the melt mask to create a layer-specific melt mask. The kernel size of this mask is determined by the following formula:

$$ksize = 2 * floor ( \frac{( maximum halfwidth ) - ( current halfwidth )}{pixel width} ) + 1$$

This erosion removes the outer edges of the geometry based on the curvature of the weld profile, which limits the predictive model to voxels within the expected weld pool area; and
d. For each of these penetration layers, anywhere the associated eroded mask has a value of 1 is marked onto the output mask as a value of 1, indicating that it is welded metal.

### Output to Data File for Visualization or Analysis

Some implementations write the output data mask to a file. This file can be one of any number of formats. For downstream volumetric data analysis, some implementations output to a standard Hierarchical Data Format version 5 (HDF5) data storage format. This is readable by a number of applications including data science scripting platforms, such as Python, Matlab, and R. For visualization, some implementations output the data to a VTK format (Visualization Toolkit). This format is readable by visualization applications, such as Paraview, which is used by machine operators to inspect the components for defects. For usage in modeling and simulation, some implementations include the following steps: generate a point cloud for the surface and identified porosity; for each layer in the output dataset, utilize contour detection with no optimization in order to find all points along the contour edges; append the z-coordinate (layer number) to each of these points; combine points from all layers into one unified dataset; apply scaling factors to convert voxel indices into real measurements (x and y are multiplied by the image pixel size, z is multiplied by the layer thickness); write the points to a plain text, comma separated output file (point cloud file); and/or import the point cloud file into software, such as Meshlab to convert the point cloud into a surface mesh STL (3D CAD) file or a finite element mesh.

### Example Fizzle Local Feature Detection Algorithm

A fizzle detection algorithm is used for the contextual or masked fizzle described above, according to some implementations. This algorithm is designed to extract textural data in images that contain noise, lighting and surface intensity gradients, and other anomalies, such as those generated by in-situ capture from additive manufacturing processes. A core concept is to measure the relative intensity change of a pixel compared to nearby pixels. This differs from a traditional gradient type edge detection algorithm in two ways. First, the output value is not directly a measurement of the change compared to adjacent pixels. In other words, the output value is not an approximation of the derivative of the image curve, but rather a measurement of how different a particular pixel is to a local region. Second, the fizzle effectively ignores linear gradients, without having to take into account any second order derivatives (such as those present in a Laplacian transform). There are two related forms of the fizzle-a basic ratio of local mean fizzle, and a context-specific masked fizzle.

### Basic Fizzle

The basic form utilizes a simple, circular shaped stencil kernel to obtain a local area mean for each pixel in the image, according to some implementations. Typically, a 25 by 25 kernel is effective.

$$Fizzle ( Pixel ) = \frac{Pixel Intensity}{max ( 1 , K ernel Mean )}$$

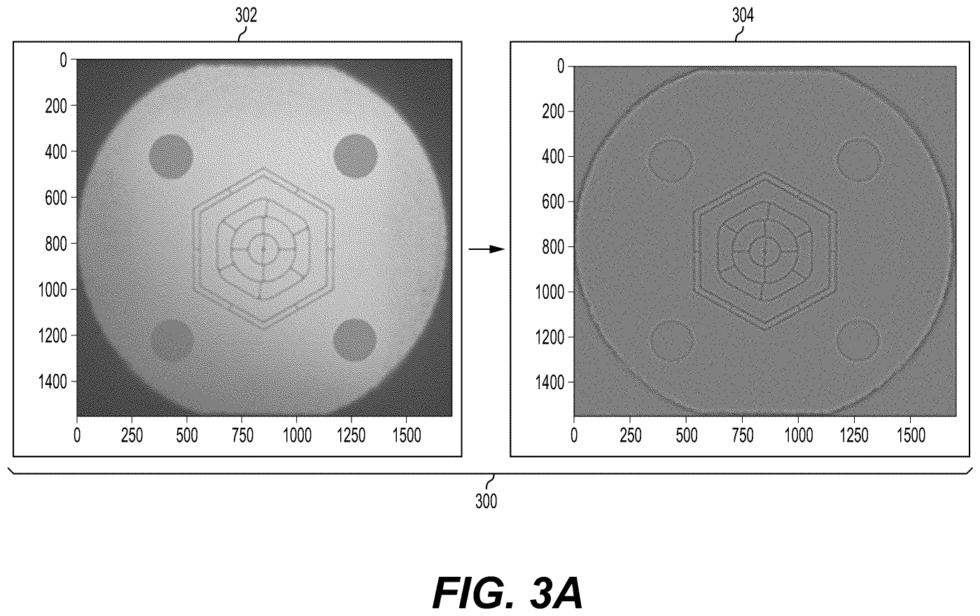

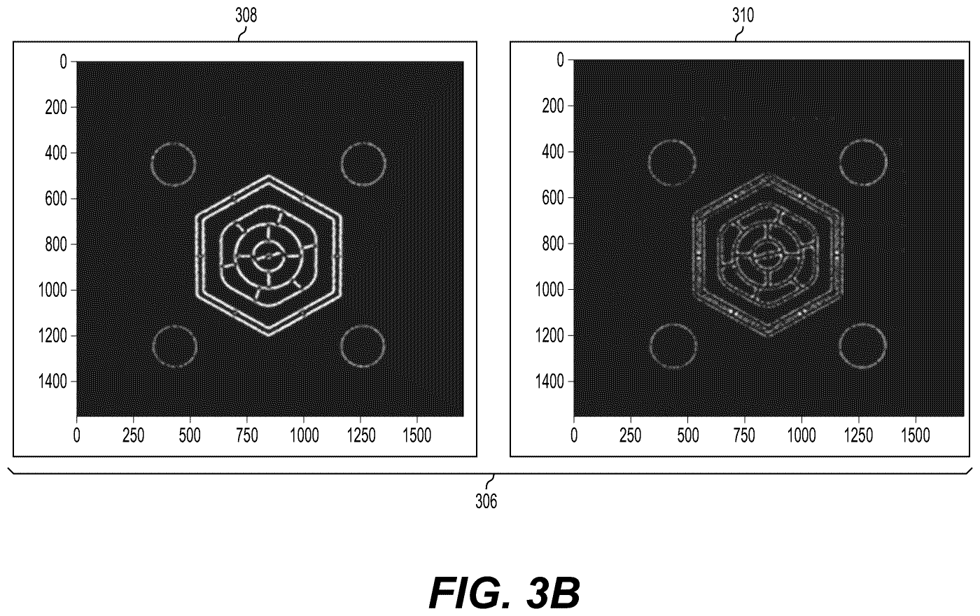

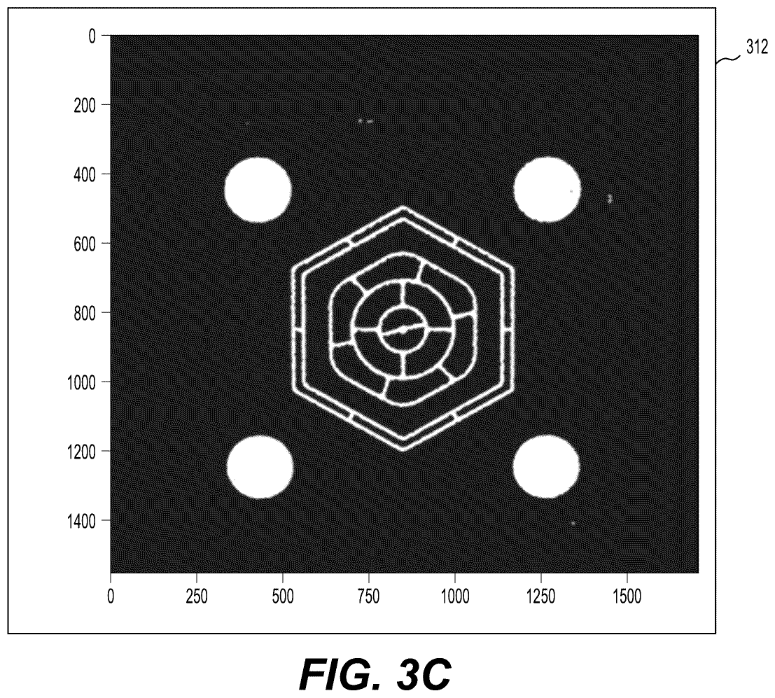

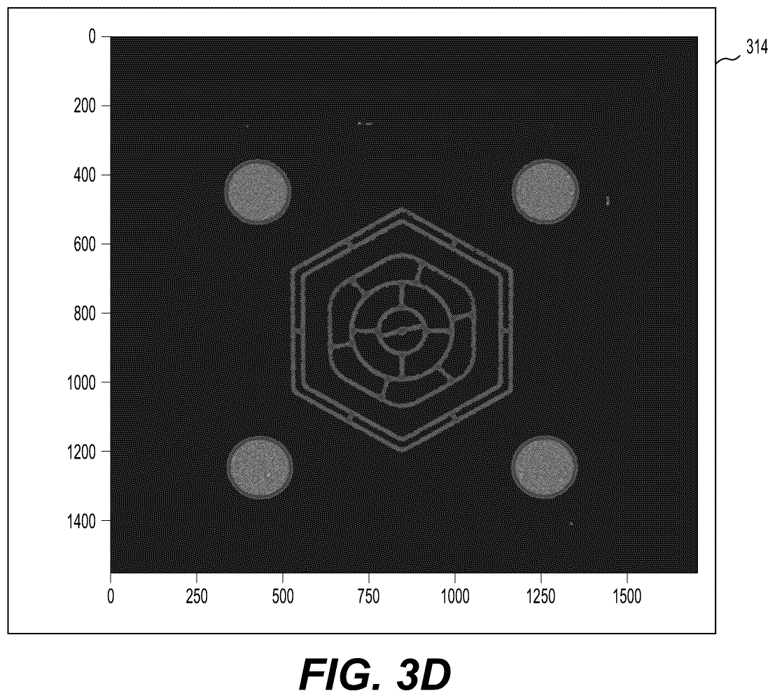

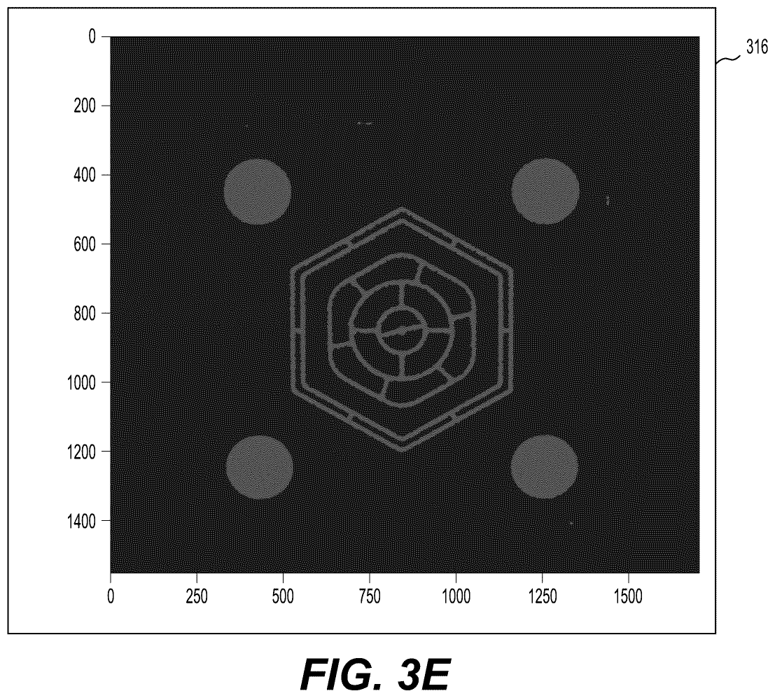

This results in a normality ratio centered around 1 that represents the intensity of a pixel compared to its neighbors. In practice, on additively manufactured materials this ratio rarely goes out of the range 0.7-1.4. The “max (1,” in the denominator eliminates the possibility of infinite values; the true maximum ratio should be 256:1. FIG. 3A shows an example visualization 300 for the basic fizzle, according to some implementations. Shown on the left is an original image 302 which is transformed into a fizzled image 304 shown on the right.

### Masked Fizzle

The basic fizzle is useful for identifying continuous edges, features, and anomalies in images that are readily visible to the human eye. However, with a simple modification it can be adapted to identify extremely subtle features in an image that may be completely undetectable to a human viewer of the images, and even more difficult to identify with standard computer vision algorithms. This is extremely useful for identifying features that may be defects in manufactured parts. The concept for this modification is very simple: alter the local mean to only take into account pixels that lie in a contiguous region that has similar intensity. There are two steps to do this. The first is identifying a viable region and creating a mask. There are many ways to perform this step. One such way that is effective for the purpose of additive manufacturing inspection is described herein for illustration.

Step 1. Mask Generation (this step may be skipped if there is already an ideal masking method). First, the image is fizzled. Then two thresholds of the image are taken-a high threshold and a low threshold. These threshold values are chosen to be extremely conservative. The purpose is to identify hard edges that are by nature of the fizzle a low region adjacent to a high region. FIG. 3B shows an example 306 for mask generation, according to some implementations. Shown on the left is an image 308 with a low threshold and shown on the right is an image 310 with a high threshold. A threshold values of 0.9 and 1.1 may be used for the images shown in FIG. 3B. These values may be adjusted depending on the contrast of active regions. These two masks are used to seed a watershed segmentation on the original image. For this step, an integer array with the same shape as the image is filled with zeros. The foreground (in this case, low fizzle) seed pixels are set to 2, while the background (high fizzle) pixels are set to 1. The watershed will then segment the regions. If the image has more consistent lighting, this step could be replaced with a simple intensity-based threshold, but this is rarely the case in real world scenarios unless the contrast between materials is extremely high, or they can be differentiated by color. An example visualization 312 of the result of the mask generation (watershed output) is shown in FIG. 3C, according to some implementations.

Step 2. Masked Contextually Sensitive Fizzle—this step uses the mask to obtain a context-sensitive fizzle. The process for this fizzling is very similar to step 1 described above. The mean of all pixels within a certain distance is calculated. However, here the values of pixels that do not fall into the mask are ignored. This is performed as follows: create a copy of the image with all non-masked pixels set to zero. In Python, this can be expressed as masked_img=img*mask. Instead of taking the mean value across the kernel, some implementations obtain the sum of all the pixels in the region, obtain the sum of all the mask values in the region, and divide the two sums:

$$Masked Fizzle ( Pixel ) = \frac{Pixel Intensity}{\frac{\sum Kernel Values}{\sum Mask Values}}$$

Some implementations use memory efficient ways to perform this without copying the image or performing two sums. Some implementations use cv2.filter2D, a vectorized stencil operation present in OpenCV. For visualization purposes, some implementations set the non-masked values to the minimum value of the masked fizzle region.

FIG. 3D shows an example 314 of an output (for masked area) from the basic fizzle, according to some implementations. FIG. 3E shows an example 316 of an output from the masked (contextual) fizzle, according to some implementations. The output from this operation looks very different from the basic fizzle. In FIG. 3D, there is a gradient of low to high intensity outputs in the fizzle inside of any bulk area. Also, even inside the thin walls, which are sufficiently thin to be detected all the way through with just a thresholded fizzle, there are geometry-induced hotspots in junctions between the walls. This illustrates how geometry affects the mean value. But by utilizing the masked fizzle, some implementations eliminate these artifacts and focus solely on the features that are truly present in the image. For example, this crack appears very obviously in the fizzle, but would not be apparent at first glance on the original image.

### Example Denoising Algorithm

Some implementations use a denoising algorithm, which removes isolated points from a detected image that are not part of a connected chain. This is performed efficiently by iterating over a series of stencil filters, which determines that a pixel has neighbors at various distances. The theory behind this is that a continuous wall will have neighbors within a nearby region. For this purpose, a minimum wall length (e.g., 720 microns) is assumed. In some implementations, the denoiser iterates over a series of various sized, unfilled square filters and passes only if at least one of the pixels in the filter shape is active. This series of operations is performed multiple times to eliminate clouds of individual points or small linked sections, and leaves only large, well-connected shapes.

### Example Watershed Algorithms

Watershed algorithms are a class of image segmentation algorithms. The image is treated as a topographical map based on intensity. Seed points within the image are used as water sources, which flood basins within the image-contiguous regions of either high or low intensity, which are separated by edges/localized minima or maxima. This has the effect of precisely identifying the boundaries between materials with different coloration, ignoring gradual changes in coloration, lighting, or other characteristics.

### Testing and Validation

For operational testing, the techniques described above were used to create models of printed parts with varying materials, geometries, and manufacturing methods and parameters. For testing dimensioning results, in order to validate the geometric accuracy of the 3D representation, multiple experimental tests described below were performed.

### Basic or Initial Geometric Test

This test was used to calibrate the pixel size of the camera configuration using measurements from the digital twin and the printed component. To calibrate the pixel size, the ratio of wall thickness to total part width was used, as this ratio should be preserved regardless of pixel size. Using the geometric feature with the largest total width provides the highest degree of precision possible for measuring the size of individual pixels. This test was repeated across both axes, as the camera is not mounted perfectly perpendicular to the build plate, leading to a slight skew between the X and Y axes. An initial sanity test was taken using a millimeter-scale ruler. Wall thickness was measured to be 1 millimeter (mm) and total part width was measured to be 30 mm, providing an aspect ratio of 1:30. At the same points on the printed parts, the output model measured on average 11 pixels for wall thickness and 334 pixels for part size, which provides an aspect ratio of 1:30.3. The same test was performed with calipers, where the exact wall thickness was measured as within 20 μm of 1 mm and 29.5 mm, respectively. Based on the scale of the outside dimensions and the ratio present, this is calculated to be the best pixel width possible for the thin wall to preserve the aspect ratio. Changing one pixel in either direction would lead to a ratio of 1:33 or 1:27.8, meaning the initial pixel size measurement had the optimal accuracy possible given the camera resolution. The results of this aspect ratio test demonstrate that the digital twin model has a geometric precision at or near the theoretical maximum based on the resolution. Based on the total-width calibration method above, a 16 Megapixel (MP) camera with 30 mm and 50 mm macro lenses resulted in 88 μm and 62 um resolutions.

### Caliper Wall Thickness Measurements

To further determine the physical accuracy of the digital measurements, measurements of thin walls and several internal features were taken on additional components using calipers. The average thickness of the wall over a 1 mm wide sample region with a 1 mm sample depth was used as the base measurement, to account for human alignment errors and possible compression of small features by the caliper jaws. The results showed that in all cases, the digital twin measurement deviated by at most 2 pixel widths, giving an accuracy of +/−1 pixel width for each feature measurement.

### Computed Tomography Scan Comparison

The 62 um resolution digital twin model was compared against a 20 um resolution CT scan of the component. Geometric measurements from the digital twin model were compared with measurements from the CT scan model. Each CT scan measurement was found to be within the specified error bars of the respective NIR measurement.

Additionally, the NIR porosity detection method was compared against the CT scan as a ground truth for accuracy. This was evaluated with six different metrics, with sensitivity (detection of true positives/inverse of false negative) ranging from a base of 98.4% of total pore volume to 100% when filtering out pores with volume below 0.002 um³. The false positive rate in all of these cases was 0 (no false positive pores were detected in this test).

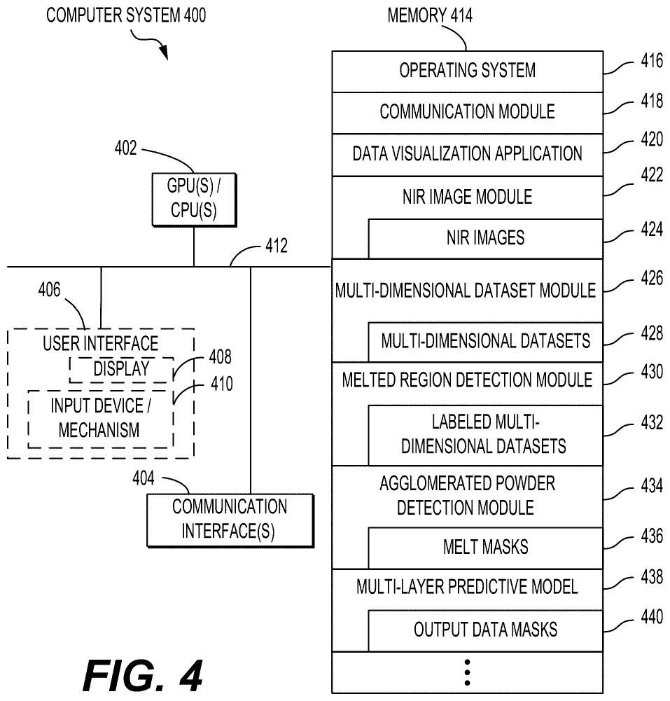

FIG. 4 is a block diagram illustrating a computing device 400 in accordance with some implementations. Various examples of the computing device 400 include high-performance clusters (HPC) of servers, supercomputers, desktop computers, cloud servers, and other computing devices. The computing device 400 typically includes one or more processing units/cores (CPUs and/or GPUs) 402 for executing modules, programs, and/or instructions stored in the memory 414 and thereby performing processing operations; one or more network or other communications interfaces 404; memory 414; and one or more communication buses 412 for interconnecting these components. The communication buses 412 may include circuitry that interconnects and controls communications between system components.

The computing device 400 may include a user interface 406 comprising a display device 408 and one or more input devices or mechanisms 410. In some implementations, the input device/mechanism includes a keyboard. In some implementations, the input device/mechanism includes a soft keyboard, which is displayed as needed on the display device 408, enabling a user to press keys that appear on the display 408. In some implementations, the display 408 and input device or mechanism 410 comprise a touch screen display (also called a touch sensitive display).

In some implementations, the memory 414 includes high-speed random access memory, such as DRAM, SRAM, DDR RAM or other random access solid state memory devices. In some implementations, the memory 414 includes non-volatile memory, such as one or more magnetic disk storage devices, optical disk storage devices, flash memory devices, or other non-volatile solid state storage devices. In some implementations, the memory 414 includes one or more storage devices remotely located from the GPU(s)/CPU(s) 402. The memory 414, or alternatively the non-volatile memory devices within the memory 414, comprise a non-transitory computer readable storage medium. In some implementations, the memory 414, or the computer-readable storage medium of the memory 414, stores the following programs, modules, and data structures, or a subset thereof:
an operating system 416, which includes procedures for handling various basic system services and for performing hardware dependent tasks;
a communications module 418, which is used for connecting the computing device 200 to other computers and devices via the one or more communication network interfaces 204 (wired or wireless) and one or more communication networks, such as the Internet, other wide area networks, local area networks, metropolitan area networks, and so on;
an optional data visualization application or module 420 for displaying visualizations of 3D models;
an NIR image module 422 for obtaining NIR images 424;
a multi-dimensional dataset module 426 for generating multi-dimensional datasets 428 based on the NIR images 424;
a melted region detection module 430 for generating labeled multi-dimensional datasets 432 based on the multi-dimensional datasets 428;
an agglomerated powder detection module 434 for generating melt masks 436 based on the labeled multi-dimensional datasets 432; and/or
a multi-layer predictive model 438 for generating output data masks 440 based on the melt masks 436.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 414 stores a subset of the modules and data structures identified above. In some implementations, the memory 414 stores additional modules or data structures not described above. The operations of each of the modules and properties of the data structures shown in FIG. 4 are further described below, according to some implementations.

Although FIG. 4 shows a computing device 400, FIG. 4 is intended more as a functional description of the various features that may be present rather than as a structural schematic of the implementations described herein. In practice, and as recognized by those of ordinary skill in the art, items shown separately could be combined and some items could be separated.

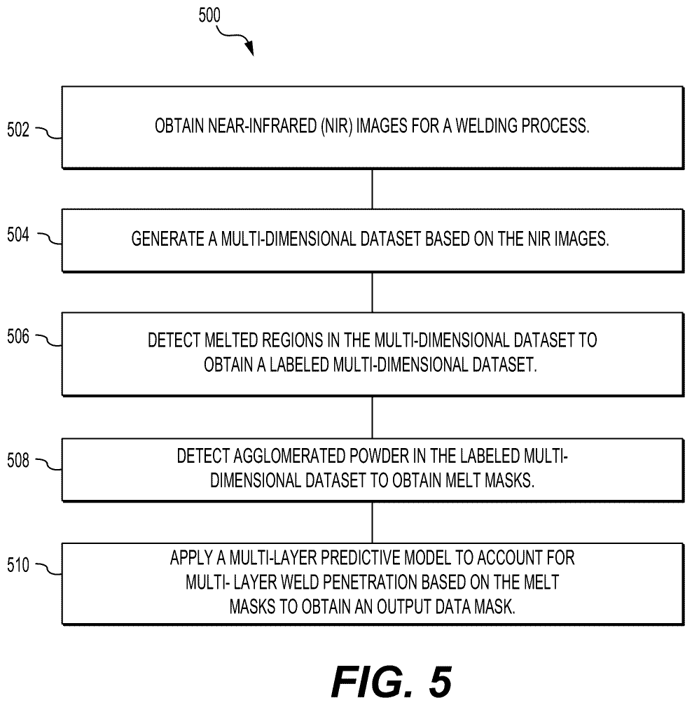

Details of the modules and data structures shown in FIG. 4 are described above in reference to FIGS. 1-3E, and further described below in reference to the flowchart shown in FIG. 5, according to some implementations.

FIG. 5 shows a flowchart of an example method 500 for unsupervised 3D modeling and geometric measurement of additively manufactured parts, according to some implementations. The method is performed at an electronic device (e.g., the computer system 400) having one or more processors (e.g., the CPU(s)/GPU(s) 402), and memory (e.g., the memory 414) storing one or more programs, configured for execution by the one or more processors. The method includes: obtaining (502) (e.g., using the NIR image module 422) near-infrared images (e.g., the NIR images 424) for a welding process; generating (504) (e.g., using the multi-dimensional dataset generation module 426) a multi-dimensional dataset (e.g., the multi-dimensional dataset 428) based on the NIR images; detecting (506) (e.g., using the melted region detection module 430) melted regions in the multi-dimensional dataset to obtain a labeled multi-dimensional dataset (e.g., the labeled multi-dimensional datasets 432); detecting (508) (e.g., using the agglomerated powder detection module 434) agglomerated powder in the labeled multi-dimensional dataset to obtain melt masks (e.g., the melt masks 436); and applying (410) a multi-layer predictive model (e.g., the model 438) to account for multi-layer weld penetration based on the melt masks to obtain an output data mask (e.g., the output data mask 440). Examples of these steps are described below, according to some implementations.

In some implementations, obtaining (502) the NIR images includes obtaining a plurality of near-infrared (NIR) images for a welding process. For the NIR images, the accuracy at minimum feature size assumes the layer camera has a resolution with pixel sizes smaller than ½ of the minimum feature size. Each NIR image corresponds to a respective layer after melting of the respective layer during the welding process for a welded part. Each NIR image may be captured shortly after melting of a respective layer is completed. These are post-weld layer images. The welded part includes welded metal and agglomerated powder particles, which are sintered or bonded to edges of melt areas. As described above, the agglomerated powder particles cannot be differentiated from un-melted powder by using thresholds or other basic image processing methods and are generally ignored by all existing optical geometric measurement methods. When the printed part consists of thin walls, when the powder size is closer to the size of the weld pool, or when the additive process utilizes sintering to stabilize the powder bed (as is the case with any electron beam welding method), there is significant error introduced with conventional methods. In some cases of extremely thin walls, powder agglomeration can account for more than 80% of the total wall thickness, which means a weld-only measurement would give an error rate of over 400%. Additionally, the edges of the weld pool may extend underneath un-melted powder, which prevents conventional detection systems from visually identifying it.

Computed Tomography scanning has major limitations when used on materials with high density, or on large components with complex internal geometries. CT scans suffer from major occurrences of visual artifacts on these kinds of components, due to shadows created by beam hardening effects, attenuation due to material density, and limitations in the reconstruction of data. Unlike CT scanning, the techniques described herein maintains a uniform level of accuracy across an entire component regardless of component size, complexity, and material density. This is a major advantage when working with highly dense materials such as those found in nuclear core components. CT scanning of non-solid components suffers from a limitation in x-ray penetration. The presence of multiple layers of material separated by voids and non-uniform geometry leads to degraded precision and increased artifacts towards the center of the component due to overlapping shadows or beam hardening effects. Additionally, increasing the total thickness or volume of the material leads to increased cost and time for CT scanning, and degraded resolution for the output data. The techniques described herein can be used to view the component from the top-down without any obstruction, so there are no shadowing effects or spatially-driven artifacts of any kind. Thus, the effectiveness of the method is not affected by component size, geometry, or material density. This is because the internal geometry is observed directly instead of mathematically reconstructed from multiple x-ray views.

In some implementations, generating (504) the multi-dimensional dataset includes generating a multi-dimensional dataset based on the plurality of NIR images, including cropping the multi-dimensional dataset to a region of interest. In some implementations, the images are arranged into a 3D volumetric dataset. For example, a 3D array is created and the image file is loaded into the array. In some implementations. The multi-dimensional dataset includes as many image layers as a number of images in the plurality of NIR images.

In some implementations, detecting (506) the melted regions includes detecting melted regions in each image layer of the multi-dimensional dataset to obtain an output volume.

In some implementations, detecting (508) the agglomerated powder includes detecting the agglomerated powder in the output volume to obtain melt masks. Each melt mask indicates weld pixels for a respective image layer. Agglomerated powder can be detected in NIR imagery because the powder is partially fused with the component, leading to heat conduction into the powder from the nearby weld regions. This results in measurably higher NIR emissions as compared to both other powder and to the base metal.

In some implementations, applying (510) the predictive model includes applying a multi-layer predictive model to account for multi-layer weld penetration, based on the melt masks, to obtain an output data mask that represents a 3D model and geometric measurements for the welded part.

In some implementations, generating the multi-dimensional dataset includes organizing the plurality of NIR images into a 3D volumetric dataset including creating a 3D array and loading of the plurality of the NIR images into the 3D array.

In some implementations, the welding process is based on an electron beam system, and cropping the multi-dimensional dataset includes: condensing the multi-dimensional dataset to a single image by computing a mean value of each pixel across an axis representing layers, including thresholding the mean value based on a predefined boundary (e.g., a boundary calibrated based on material emissivity and camera settings), to create a mask of a known preheated powder; cropping the single image to an outside boundary of the region of interest to obtain a cropped image; and applying the mask of the known preheated powder to mask any value outside the cropped image. This is necessary because low intensity values of non-preheated powder may be considered false positives by the melt detection algorithm. This operations is safe because the preheated area will always extend beyond any printed material. In some implementations, the predefined boundary includes a lower boundary or a high pass threshold, which is the minimum intensity that would be considered preheated powder. This value may be calculated automatically. In most cases, the mean value of the condensed image would suffice as a lower threshold (as there is typically 50% or more unheated pixels with very low intensity, and the mean value would be halfway between the high intensity and low intensity peaks). A more sophisticated automated method takes a histogram of the pixel values for the full condensed image and then picks the bucket with the minimum number of pixels in it as the threshold. Note that although the cropping is described as being performed on a single image, it is not the single image that is cropped. Instead, the whole dataset is cropped to the bounds of the masked out preheated area as obtained by the previous threshold. This means cropping the images down to the rectangular region enclosing the preheat area, and then ignoring all pixels not within the preheat area during subsequent calculations. In some implementations, the region of interest may be referred to as preheat (or preheated) region of interest. In the electron beam additive manufacturing process, powder is preheated on each layer to loosely sinter the powder together before welding in order to prevent the powder from scattering when it becomes electrically charged during welding. This preheat region encloses the entire printed geometry, and no welds are performed outside of this region.

In some implementations, the welding process is based on a laser system, and cropping the multi-dimensional dataset includes: (i) condensing the multi-dimensional dataset to a single image by computing a minimum value for each pixel across an axis representing the layers (e.g., the Z-axis) (potentially ignoring a first few layers as the build plate is visible), including thresholding each minimum value, to create a mask of locations with a melted metal; and (ii) denoising (eroding) the mask of locations to remove any anomalous isolated low values. This denoising step is sometimes referred to as a morphological opening. This step may include an erosion followed by a dilation, which removes small particles but leaves the rest of the geometry unchanged. The weld mask is dilated, not the condensed image. Individual pixels or small clusters of pixels in an image may have low values for reasons unrelated to the welding process (e.g., feedstock contaminants, spatter from welding). Since the condensed image mask contains every pixel that has a weld on any layer, any isolated spot cannot possibly be part of the component geometry as they would be unconnected and floating in space. The cropping further includes (iii) cropping the single image to an area around the outside of the mask, adding a buffer or margin around the region of interest, thereby ensuring full capture of details. In order to create a margin around the space, the denoised weld mask is dilated. Melted/welded metal may appear to be darker/lower intensity than the surrounding powder due to having a smooth surface as compared to the powder. In the laser powder bed fusion process, preheating powder is not a standard practice, and there is typically illumination inside the chamber, which eliminates the need for cropping/masking out the heated area prior to detecting welds (as the unused areas in the image do not have lower intensity than other powder). In some implementations, thresholding each minimum value includes taking the minimum value from the image stack and low-pass thresholding it to create a mask which shows every pixel in the image space which has a weld at any layer. The mask of locations is sometimes referred to as a weld mask or geometry mask.

In some implementations, detecting the melted regions includes: applying a fizzle algorithm to each image layer to simultaneously intensity-normalize and amplify features or local gradients, to obtain a respective fizzled image. The fizzle algorithm is a local feature detection algorithm that measures relative intensity change of a pixel compared to a local region. Detecting the melted region further includes generating a respective labeled mask for each fizzled image by (i) annotating high-confidence known weld pixels with a first value, where the pixels are identified using a low-pass threshold (e.g., a threshold calibrated on a per-material basis, a threshold of 90% of the local mean (a 0.9 fizzle value) as the upper bounds, across multiple materials), (ii) identifying and masking high-confidence known powder areas with a second value using a high-pass threshold (e.g., 110% of the local mean (a 1.1 fizzle value) as the lower bounds), (iii) filling remaining unlabeled values with a third value, and (iv) denoising to remove isolated labels. The method further includes segmenting each image layer (the original image or a lighting corrected version) using the respective labeled mask as a seed and using a seeded segmentation algorithm (e.g., a watershed algorithm) to obtain a respective segmented output; and labelling each image layer to indicate material or weld present for each first value in the respective segmented output, to obtain the output volume. In some implementations, denoising to remove isolated labels includes removing isolated points from the fizzled image that are not part of a connected chain. In some implementations, this step is performed efficiently by iterating over a series of stencil filters, which determine that a pixel has neighbors at various distances. The theory behind this is that a continuous wall will have neighbors within a nearby region. A minimum wall length (e.g., 720 microns) may be assumed. In some implementations, the denoiser iterates over a series of various sized, unfilled square filters and passes only if at least one of the pixels in the filter shape is active. This series of operations is performed multiple times to eliminate clouds of individual points or small linked sections, and leaves only large, well-connected shapes.

In some implementations, the seeded segmentation algorithm is a watershed algorithm for identifying boundaries between materials with different coloration, ignoring gradual changes in coloration, lighting, or other characteristics (e.g., textural features, non-relative value of pixels). For example, an image is treated as a topographical map based on intensity, seed points within the image are used as water sources, with flood basins within the image (e.g., contiguous regions of either high or low intensity), which are separated by edges or localized minima or maxima.

In some implementations, detecting the agglomerated powder includes: (i) obtaining a respective input melt mask indicating weld pixels for each image layer (the melt mask is based on the output volume, which includes labels for each image layer to indicate material or weld present); (ii) applying a contextual fizzle algorithm to each image layer using a negative (or inverse) of the respective input melt mask in order to identify local thermal gradients in powder, to obtain a respective fizzled image (the contextual fizzle algorithm is a local feature detection algorithm that measures relative intensity change of a pixel compared to a local region, alters a local mean to only consider pixels that belong to a contiguous region that has similar intensity); (iii) applying a high-pass threshold to each fizzled image to identify superheated powder in each input melt mask; (iv) applying a morphological dilate filter to each input melt mask, with a kernel size sufficient to capture agglomerated powder to obtain a respective dilated melt mask (the dilated melt mask can be determined empirically by sampling measurements from microscopy imagery, or can be set to a default value of 2 times the powder diameter if the empirical data is unavailable); (v) generating a respective output melt mask for each input melt mask based on marking a first value for any pixel for which both the high-pass threshold and the first value on the dilated melt mask are present (this can be another value to indicate the presence of powder agglomeration, if desired as an output); and (vi) applying a morphological close filter to each output melt mask to fill in gaps between the identified superheated powder in each input melt mask. The input mask represents a known component geometry. Some implementations identify superheated powder within a predefined distance from the known welds, and then expand this known weld region to include the superheated powder. The kernel size may be the same as the dilate range.

In some implementations, applying the multi-layer predictive model includes accounting for weld pool depth being more than one layer thickness deep. As described above, this is a requirement for powder bed fusion-based additive manufacturing in order to fully adhere each layer to the previous layer. In some processes, the powder diameter is often close to the weld pool size (within an order of magnitude in electron beam melting (EBM)). So there can be a high degree of randomness in the weld width and shape based on the random positioning of powder particles, especially on the edges of the component. As a result of this randomness, the final geometry of a layer is actually a combination of its own shape as measured in the NIR, and the penetrated weld from layers above it. This can also have the effect of eliminating lack of fusion porosity by re-melting the region and adding additional material, causing pores to heal.

In some implementations, the predictive model utilizes physical measurements with test samples. Microscopy on an etched vertical cross section of a test sample may be used to determine machine-specific weld pool penetration depth on a material in question. Due to overlapping welds, the average maximum weld depth is used to predict penetration for all pixels internal to the component, with a taper around the edges based on the weld shape.

In some implementations, applying the multi-layer predictive model includes generating an output data mask that includes a respective output mask for each image layer where the melt mask has a first value. In some implementations, this step includes: (i) obtaining a maximum depth in number of layers, a maximum half-width, and a half-width of a weld pool for each image layer in a depth range; (ii) for each penetration layer in the depth range (in the output dataset/geometry) except the top layer, applying a morphological erosion kernel to its respective melt mask to create a layer-specific melt mask. Kernel size is determined by

$$ksize = 2 * floor ( \frac{( maximum halfwidth ) - ( current halfwidth )}{pixel width} ) + 1.$$

This erosion removes the outer edges of the geometry based on the curvature of the weld profile, which limits the predictive model to voxels within the expected weld pool area). The step also includes (iii) marking locations (or pixels), in the respective output mask, where the layer-specific melt mask has the first value, indicating that the locations correspond to welded metal. Data is propagated through multiple layers while accounting for the weld pool. For each penetration layer, the erosion is performed separately based on the half width as shown in FIG. 2. For each penetration layer (layer below the current layer), a copy of the output geometry for the current layer, starting from the bottom of the array (which may be performed in real time as the layers are added), is eroded according to the halfwidth of the weld starting with no erosion; increasing the erosion as the weld depth becomes higher and the weld region becomes narrower. This eroded region is then combined with the already existing output for the penetration layer using a logical OR. Any pixel that is solid metal in either the eroded current layer or the original output layer is marked as solid metal in the output for the previous or penetration layer.

In some implementations, the method further includes annotating the output volume with porosity defects. In a void-based method, annotating the output volume with porosity defects includes: for each layer in the output volume, using a contour detection method on the labeled output for the layer to identify interior (negative) and exterior (positive) contours around material regions. Some implementations use the Suzuki & Be contour detection algorithm found in the OpenCV library. Annotating also includes filtering the contours based on criteria including (i) interior pores only (only voids inside of known material regions are considered as candidates), (ii) low-pass threshold on total contour area (this is the maximum void size that will be considered a pore; anything larger than this will simply be output as component geometry, and this value is set to below the minimum designed internal void cross-sectional area), and (iii) geometric characteristics (e.g., circularity). The annotating also includes mapping the filtered contours onto the output volume with a label to indicate a presence of defect. A context-sensitive defect detection method may be used when the increased emissivity of pores is insufficiently bright to be classified by the melt detector as a non-melt region. This can also be used in combination with the void-based method to identify smaller pores that may not be identified by that method. In this method, annotating the output volume with porosity defects includes: for each layer in the output volume, using a masked contextual fizzle local anomaly detection algorithm on the layer images (images in the input NIR images, for the layer in the output volume), using known material regions from the output volume as a mask, to obtain a fizzled image; applying a high-pass threshold to the fizzled image using a predetermined value based on a sample image, to identify any hotspots in a melt region that exceed the threshold, to obtain a threshold mask; using a contour detection algorithm on the threshold mask to identify contours of individual pores; filtering the contours based on total area, to indicate whether the contours contain internal solid regions, and circularity or convexity (this filters out other types of defects picked up by the anomaly detector, such as cracking, swelling, and non-pore thermal hotspots); and mapping the filtered contours onto the output volume with a label to indicate the presence of a defect. In some implementations, the output data is 8 bits, which may be treated as a bitmask containing multiple flags (e.g., 0 means not geometry, 1 means welded metal, and 2 means porosity). The final external geometry may include all voxels with any nonzero value, while the geometry including voids due to porosity may include all voxels exactly equal to one. This data format also allows for the addition of other types of defects/annotations, without changing the data processing or visualization methods.

In some implementations, the method further includes writing the output data mask for downstream volumetric data analysis, to a standard HDF5 data storage format. This format is readable by a number of applications including data science scripting platforms such as Python, Matlab, and R).

In some implementations, the method further includes writing the output data mask for downstream volumetric data analysis, to a visualization toolkit (VTK) format. This format is readable by visualization applications, such as Paraview, which is used by machine operators to inspect the components for defects.

In some implementations, the method further includes writing the output data mask for usage in modeling and simulation.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for unsupervised 3D modeling and geometric measurement of additively manufactured parts, the method comprising:
obtaining a plurality of near-infrared (NIR) images for a welding process, wherein each NIR image corresponds to a respective layer after melting of the respective layer during the welding process for a welded part, and wherein the welded part includes welded metal and agglomerated powder particles that are sintered or bonded to edges of melt areas;
generating a multi-dimensional dataset based on the plurality of NIR images, including cropping the multi-dimensional dataset to a region of interest, wherein the multi-dimensional dataset includes as many image layers as a number of images in the plurality of NIR images;
detecting melted regions in each image layer of the multi-dimensional dataset to obtain an output volume;
detecting agglomerated powder in the output volume to obtain melt masks, wherein each melt mask indicates weld pixels for a respective image layer; and
applying a multi-layer predictive model to account for multi-layer weld penetration, based on the melt masks, to obtain an output data mask that represents a 3D model and geometric measurements for the welded part.

2. The method of claim 1, wherein generating the multi-dimensional dataset comprises:
organizing the plurality of NIR images into a 3D volumetric dataset including creating a 3D array and loading of the plurality of NIR images into the 3D array.

3. The method of claim 1, wherein the welding process is based on an electron beam system.

4. The method of claim 3, wherein cropping the multi-dimensional dataset comprises:
condensing the multi-dimensional dataset to a single image by computing a mean value of each pixel across an axis representing layers, including thresholding the mean value based on a predefined boundary to create a mask of a known preheated powder;
cropping the single image to an outside boundary of the region of interest to obtain a cropped image; and
applying the mask of the known preheated powder to mask any value outside the cropped image.

5. The method of claim 1, wherein cropping the multi-dimensional dataset comprises:
condensing the multi-dimensional dataset to a single image by computing a minimum value for each pixel across an axis representing layers, including thresholding each minimum value, to create a mask of locations with a melted metal;
denoising the mask of locations to remove any anomalous isolated low values; and
cropping the single image to an area around the outside of the mask, adding a buffer or margin around the region of interest.

6. The method of claim 1, wherein the welding process is based on a laser system.

7. The method of claim 6, wherein cropping the multi-dimensional dataset comprises:
condensing the multi-dimensional dataset to a single image by computing a minimum value for each pixel across an axis representing layers, including thresholding each minimum value, to create a mask of locations with a melted metal;
denoising the mask of locations to remove any anomalous isolated low values; and
cropping the single image to an area around the outside of the mask, adding a buffer or margin around the region of interest.

8. The method of claim 1, wherein detecting the melted regions comprises:
applying a fizzle algorithm to each image layer to simultaneously intensity-normalize and amplify features or local gradients, to obtain a respective fizzled image, wherein the fizzle algorithm is a local feature detection algorithm that measures relative intensity change of a pixel compared to a local region;
generating a respective labeled mask for each fizzled image by (i) annotating high-confidence known weld pixels with a first value, wherein the pixels are identified using a low-pass threshold, (ii) identifying and masking high-confidence known powder areas with a second value using a high-pass threshold, (iii) filling remaining unlabeled values with a third value, and (iv) denoising to remove isolated labels;
segmenting each image layer using the respective labeled mask as a seed and using a seeded segmentation algorithm to obtain a respective segmented output; and
labelling each image layer to indicate material or weld present for each first value in the respective segmented output, to obtain the output volume.

9. The method of claim 8, wherein denoising to remove isolated labels comprises removing isolated points from the respective fizzled image that are not part of a connected chain.

10. The method of claim 8, wherein the seeded segmentation algorithm is a watershed algorithm for identifying boundaries between materials with different coloration, ignoring gradual changes in coloration, lighting, or other characteristics.

11. The method of claim 1, wherein detecting the agglomerated powder comprises:
obtaining a respective input melt mask indicating weld pixels for each image layer;
applying a contextual fizzle algorithm to each image layer using a negative of the respective input melt mask in order to identify local thermal gradients in powder, to obtain a respective fizzled image, wherein the contextual fizzle algorithm is a local feature detection algorithm that measures relative intensity change of a pixel compared to a local region, alters a local mean to only consider pixels that belong to a contiguous region that has similar intensity;
applying a high-pass threshold to each fizzled image to identify superheated powder in each input melt mask;
applying a morphological dilate filter to each input melt mask, with a kernel size sufficient to capture agglomerated powder to obtain a respective dilated melt mask;
generating a respective output melt mask for each input melt mask based on marking a first value for any pixel for which both the high-pass threshold and the first value on the respective dilated melt mask are present; and
applying a morphological close filter to each output melt mask to fill in gaps between the identified superheated powder in each input melt mask.

12. The method of claim 1, wherein applying the multi-layer predictive model comprises accounting for weld pool depth being more than one layer thickness deep.

13. The method of claim 1, wherein the multi-layer predictive model uses physical measurements with test samples, and wherein microscopy on an etched vertical cross section of a test sample is used to determine machine-specific weld pool penetration depth on a material in question.

14. The method of claim 1, wherein applying the multi-layer predictive model comprises:
generating the output data mask that includes a respective output mask for each image layer whose melt mask has a first value, including:
obtaining a maximum depth in number of layers, a maximum half-width, and a half-width of a weld pool for each image layer in a depth range;
for each penetration layer in the depth range except a top layer, applying a morphological erosion kernel to its respective melt mask to create a layer-specific melt mask, wherein kernel size is determined by
$$ksize = 2 * floor ( \frac{( maximum halfwidth ) - ( current halfwidth )}{pixel width} ) + 1 ; .$$
and
marking locations, in the respective output mask, where the layer-specific melt mask has the first value, indicating that the locations correspond to welded metal.

15. The method of claim 1, further comprising annotating the output volume with porosity defects.

16. The method of claim 15, wherein annotating the output volume with porosity defects comprises:
for each layer in the output volume:
using a contour detection method on labeled output for the layer to identify interior (negative) and exterior (positive) contours around material regions;
filtering the contours based on criteria including (i) interior pores only, (ii) low-pass threshold on total contour area, and (iii) geometric characteristics; and
mapping the filtered contours onto the output volume with a label to indicate a defect presence.

17. The method of claim 15, wherein annotating the output volume with porosity defects comprises:
for each layer in the output volume:
using a masked contextual fizzle local anomaly detection algorithm on the layer images, using material regions from the output volume as a mask, to obtain a fizzled image;
applying a high-pass threshold to the fizzled image using a predetermined value based on a sample image, to identify any hotspots in a melt region that exceed the threshold, to obtain a threshold mask;
using a contour detection algorithm on the threshold mask to identify contours of individual pores;
filtering the contours based on total area, to indicate whether the contours contain internal solid regions, circularity, or convexity; and
mapping the filtered contours onto the output volume with a label to indicate a defect presence.

18. The method of claim 1, further comprising:
writing the output data mask for downstream volumetric data analysis, to a standard HDF5 data storage format.

19. The method of claim 1, further comprising:
writing the output data mask for downstream volumetric data analysis, to a visualization toolkit (VTK) format.

20. The method of claim 1, further comprising:
writing the output data mask for usage in modeling and simulation.

21. A computer system for unsupervised 3D modeling and geometric measurement of additively manufactured parts, the computer system comprising:
one or more processors; and
memory;
wherein the memory stores one or more programs configured for execution by the one or more processors, and the one or more programs comprise instructions for performing the method of claim 1.

22. A non-transitory computer readable storage medium storing one or more programs configured for execution by a computer system having one or more processors and memory, the one or more programs comprising instructions for performing the method of claim 1.
